(19) United States
(12) Patent Application Publication
(10) Pub. No.: US 2010/0243286 A1
(43) Pub. Date: Sep. 30, 2010

(54) POWER TOOL AND CUSHIONING MECHANISM THEREOF

(75) Inventors: Takamichi Hoshino, Tokyo (JP); Toshimichi Arai, Tokyo (JP); Yasunori Aihara, Tokyo (JP)

Correspondence Address: DRINKER BIDDLE & REATH (DC), 1500 K STREET, N.W., SUITE 1100, WASHINGTON, DC, 20005-1209, US

(73) Assignee: Max Co., Ltd., Tokyo (JP)

(21) Appl. No.: 12/438,435

(22) PCT Filed: Aug. 22, 2007
(86) PCT No.: PCT/JP2007/066309

§ 371 Date: Feb. 23, 2009

(30) Foreign Application Priority Data
Aug. 24, 2006 (JP) 2006-228465

(51) Int. Cl. B25C 7/00

(52) U.S. Cl. 173/211; 227/156

(57) ABSTRACT

A power tool includes a striking cylinder, a striking piston slidably housed in the striking cylinder, a driver coupled to a bottom surface of the striking piston, and a cushioning mechanism configured to absorb an impact of striking a fastener with the driver when the striking piston is driven. The cushioning mechanism includes a housing formed below the striking cylinder, and a bumper housed in the housing to receive the bottom surface of the striking piston. The bumper is formed in a tubular shape, a wall thickness of a central section of the bumper is greater than wall thicknesses of an upper section and a lower section of the bumper, and the wall thicknesses of the upper section and the lower section are substantially the same.

### TECHNICAL FIELD

The present invention relates to a cushioning mechanism of power tools such as pneumatic tools and gas combustion type tools.

### BACKGROUND ART

A pneumatic tool strikes a fastener, such as a nail, a screw or a staple, toward a material to be nailed using a driver coupled to a striking piston by driving the striking piston using compressed air. Generally, such a pneumatic tool includes a cushioning mechanism for absorbing an impact from the striking piston. The cushioning mechanism includes a cylindrical bumper which is usually arranged below a striking cylinder to receive the bottom surface of the striking piston and to absorb the impact from the striking piston.

For example, JP 2876982 B2 discloses a hollow cylindrical bumper which is formed such that an inner diameter and an outer diameter of a lower section are respectively larger than an inner diameter and an outer diameter of an upper section. When an impact from a striking piston is exerted on the bumper, the hollow portion allows a portion of the compressed bumper to deform therein, whereby the effect of absorbing the impact from the striking piston is enhanced.

JP 2576575 Y2 discloses a cylindrical bumper having a thick upper section which is formed to have an outer diameter being almost the same dimension as an inner diameter of a corresponding portion of a housing, an intermediate section which is bulged along an inner face of a lower portion the housing which is also bulged, and a lower section which is formed thinner such that a void is created between the lower section and an inner face of a corresponding portion the housing. According to this configuration, the lower section of the bumper is easily deformable, and the effect of absorbing an impact from a striking piston is enhanced by allowing the lower section to deform into the void.

JP 3267469 B2 discloses a bumper which is formed such that an inner diameter and an outer diameter of a lower section are respectively larger than an inner diameter and an outer diameter of an upper section and such that a space is provided inside the lower section. When an impact from a striking piston is exerted on the bumper, the upper section of the bumper is inwardly deformed, thereby closing the clearance between a driver and a driver guide hole and compressing the air enclosed in the space inside the lower section. Accordingly, the impact absorbing effect is enhanced by utilizing a synergistic effect of the elasticity of the bumper and the air cushioning.

The above bumpers are designed to directly receive the bottom surface of the striking piston on the upper section and to transmit the impact from the striking piston from a central section to a lower section to absorb the impact. Thus, all the bumpers have a common configuration that respective shapes of the bumpers are vertically asymmetric. More specifically, the upper section is configured to receive the impact from the striking piston with a large area, and the lower section is configured to relatively deformable than the upper section by providing a space (a void).

Meanwhile, recent pneumatic tools use compressed air of much higher pressure than before and tend to have higher outputs. However, the bumpers described above do not necessarily have a sufficient cushioning function in high-output pneumatic tools.

Because the upper sections of the bumpers described above are configured to receive the impact from the striking piston with a large area, at the time when they receive a strong impact from the striking piston of a high-output pneumatic tool, the upper section is largely deformed. As a result, the impact may be absorbed without sufficiently transmitting the impact received by the upper section to the easily deformable lower section, that is, only the upper section may deform, so that the bumper may not function properly.

That is, the bumpers described above cannot suitably suppress a sudden increase of the impact from the striking piston that is driven with high pressure when absorbing the impact. Further, a large flexural deformation of the upper section hampers uniform flexural deformation of the upper and lower sections, and accelerates degradation of the upper section alone.

Therefore, in order to effectively absorb the impact from the striking piston that is driven with high pressure, in has been necessary to increase the size and the mass of the bumper.

### DISCLOSURE OF THE INVENTION

One or more embodiments of the present invention provide a power tool and a cushioning mechanism thereof which includes a bumper having an improved shock-absorbing function and durability without increasing its size.

According to one or more embodiments of the present invention, a power tool includes a striking cylinder, a striking piston slidably housed in the striking cylinder, a driver coupled to a bottom surface of the striking piston, and a cushioning mechanism configured to absorb an impact of striking a fastener with the driver when the striking piston is driven. The cushioning mechanism includes a housing formed below the striking cylinder, and a bumper housed in the housing to receive the bottom surface of the striking piston. The bumper is formed in a tubular shape, a wall thickness of a central section of the bumper is greater than wall thicknesses of an upper section and a lower section of the bumper, and the wall thicknesses of the upper section and the lower section are substantially the same.

According to one or more embodiments of the present invention, a shape of the bumper is symmetric with respect to the central section.

According to one or more embodiments of the present invention, an inner diameter of the central section is smaller than inner diameters of the upper section and the lower section, and an outer diameter of the central section is larger than outer diameters of the upper section and the lower section.

According to one or more embodiments of the present invention, the central section has such an inner diameter that, when the bumper is maximally deformed due to the impact from the striking piston, an inner peripheral surface of the central section does not contact the driver.

According to one or more embodiments of the present invention, outer peripheral surfaces of the upper section and the central section are in contact with an inner surface of the housing, and a space is provided between an outer peripheral surface of the lower section and the inner surface of the housing.

### BRIEF DESCRIPTION OF THE DRAWINGS

FIG. 1 is a vertical sectional view of a nailer according to an embodiment of the present invention.

FIG. 2 is an enlarged sectional view of a portion including a bumper.

FIG. 3 is a perspective view of a bumper according to a first embodiment of the present invention.

FIG. 4A illustrates a state of the bumper against which a bottom surface of a driven striking piston has been collided but immediately before its deformation.

FIG. 4B illustrates a deformed state of the bumper which is deformed by being pushed downward due to the collision of the striking piston.

FIG. 4C illustrates another deformed state of the bumper in a final stage at which the striking piston reaches a bottom dead center.

FIG. 5 is a perspective view of a bumper according to a second embodiment of the present invention.

FIG. 6A is a plan view of the bumper illustrated in FIG. 5.

FIG. 6B is a side view of the bumper illustrated in FIG. 5.

FIG. 6C is a sectional view taken along the line X-X of FIG. 6B.

### EXPLANATION OF REFERENCE NUMERALS

A: Nailer

1: Body

6: Striking Cylinder

7: Striking Piston

8: Driver

15: Bumper

16: Housing

### BEST MODE FOR CARRYING OUT THE INVENTION

Hereinafter, embodiments of the present invention will be described in detail with reference to the drawings.

### First Embodiment

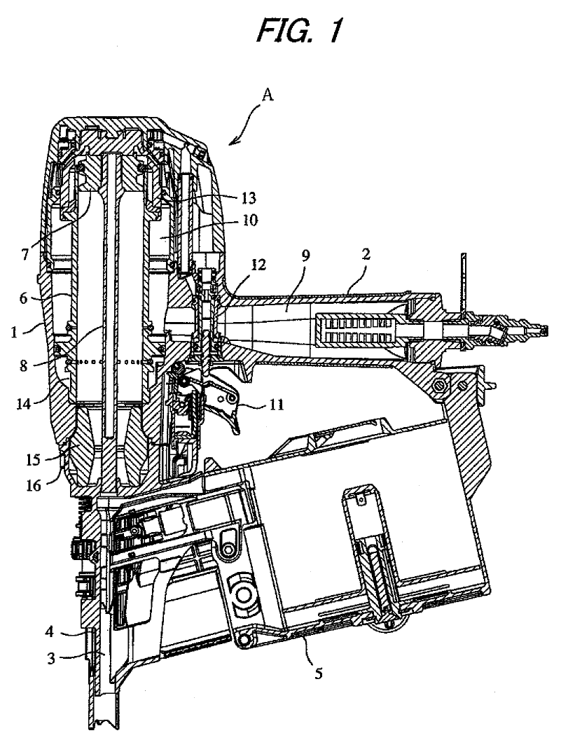

As shown in FIG. 1, a nailer A includes a body 1, a grip 2 provided on a rear side of the body 1, and a nose part 4 arranged below the body 1. The body 1, the grip 2 and the nose part 4 are integrally arranged. The nose part 4 has a ejecting port 3, and a magazine 5 which feeds nails to the ejecting port 3 is attached on a rear side of the nose part 4. Inside the body 1, a driving unit including a striking cylinder 6 and a striking piston 7 is housed and the striking piston 7 is slidably housed inside the striking cylinder 6. A driver 8 is integrally coupled to a bottom surface of the striking piston 7, and the driver 8 slides inside the ejecting port 3 of the nose part 4.

An air chamber 10 is formed inside the body 1 to reserve compressed air which is supplied from a compressed air supply source (not shown), such as an air compressor, through a supply channel 9 inside the grip 2.

When a trigger lever 11 is pulled to actuate an activation valve 12 with a tip end of the nose part 4 being pressed against a material to be nailed, a head valve 13 is opened to supply the compressed air inside the air chamber 10 toward a top surface of the striking piston 7 inside the striking cylinder 6, whereby the striking piston 7 and the driver 8 are driven downward to strike a nail (not shown) which is supplied to the ejecting port 3 of the nose part 4 from the magazine 5.

Thereafter, the striking piston 7 upwardly moves and returns to an initial top dead center, due to the air compressed by the striking and stored in a blowback chamber 14 around the striking cylinder 6, to stand by for the subsequent nailing.

A housing 16 is formed between a lower end portion of the striking cylinder 6 and the nose part 4 and in a location corresponding to the bottom dead center of the striking piston 7. A bumper 15 (a shock absorber) is arranged Inside the housing 16 to receive the bottom surface of the striking piston 7 that has been driven downward for the nailing.

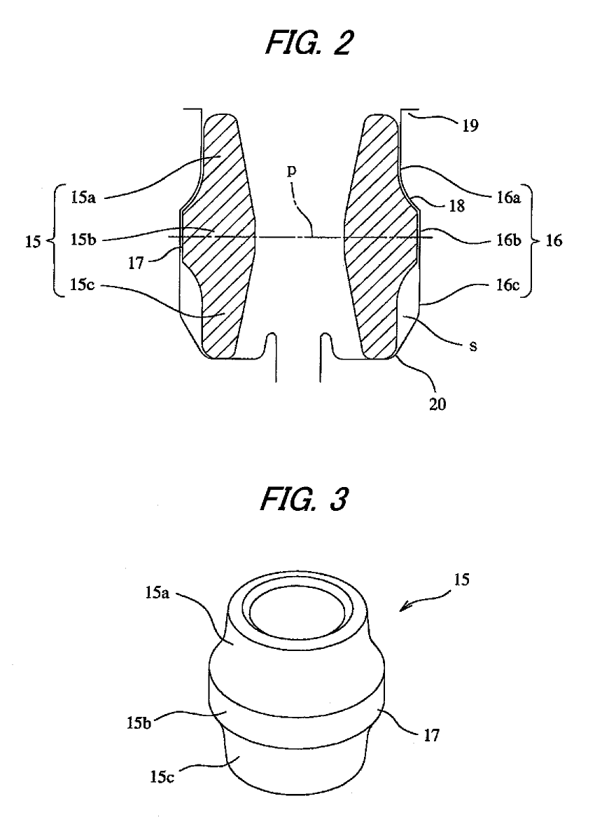

As shown in FIGS. 2 and 3, according to the first embodiment, the bumper 15 is formed in a slightly distorted hollow cylinder of an elastic material such as rubber. A wall thickness of a central section 15b of the bumper 15 is greater than wall thicknesses of an upper section 15a and a lower section 15c, and the wall thicknesses of the upper section 15a and the lower section 15c are about the same. An inner diameter of the central section 15b of the bumper 15 is smaller than inner diameters of the upper section 15a and the lower section 15c. More specifically, an inner peripheral surface from the upper section 15a toward the central section 15b and an inner peripheral surface from the lower section 15c toward the central section 15b are tapered such that the hollow region is narrow at the center thereof. An outer diameter of the central section 15b is larger than outer diameters of the upper section 15a and the lower section 15c. More specifically, an outer side portion 17 of the central section 15b is gradually protruded in a trapezoidal shape. The bumper 15 is formed in a symmetric shape with respect to the central section (a central cross section p). The central section 15b is formed to have such an inner diameter that, when the bumper 15 is maximally deformed by a collision of the bottom surface of the striking piston 7, an inner peripheral surface of the central section 15b does not contact the driver 8.

While the bumper 15 is formed symmetric with respect to the central cross section p, the “upper” part 15a and the “lower” part 15c are discriminated from each other in this description for the convenience of explanation.

An inner diameter of an upper section 16a of the housing 16 is smaller than inner diameters of a central section 16b and a lower section 16c. An inner surface 18 from the upper section 16a to the central section 16b has a warped shape along an outer peripheral surface from the upper section 15a to the central section 15b of the bumper 15. The inner diameter of a portion of the lower section 16c continuing to the central section 16b is about the same as the inner diameter of the central section 16b. An inner diameter near a lower end 20 of the lower section 16c is narrowed, and an inner diameter of the lower end 20 is about the same as the inner diameter of an upper end 19.

When the bumper 15 is housed in the housing 16, the outer peripheral surfaces of the upper section 15a and the central section 15b of the bumper 15 are substantially in contact with the inner peripheral surface of the upper section 16a and the central section 16b of the housing 16, and a space s is created between the outer peripheral surface of the lower section 15e of the bumper 15 and the inner peripheral surface of the lower section 16c of the housing 16.

The symmetric shape of the bumper may have a straight inner peripheral surface by making the inner diameter of the central section to be the same as the inner diameters of the upper section and the lower section.

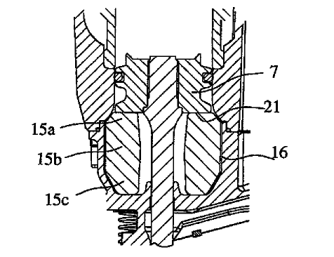

As shown in FIG. 4A, the bumper 15 is housed in the housing 16 and receives the bottom surface 21 of the striking piston 7 in the location corresponding to the bottom dead center of the striking piston 7. The inner peripheral surface of the bumper 15 is spaced apart from the driver 8 to allow the movement of the driver 8. The lower section 15c of the bumper 15 is arranged at a position slightly spaced apart from a lower opening portion of the striking cylinder 6.

When the striking piston 7 is driven and is moved down by the compressed air for nailing so that the bottom surface 21 of the striking piston 7 collides against the upper section 15a of the bumper 15, the bumper 15 starts to flexurally deform as shown in FIG. 4A.

As the striking piston 7 is further moved down, the upper section 15a having the thinner wall thickness is compressively deformed in a shrinking manner. As shown in FIG. 4B, because the wall thickness of the lower section 15c of the bumper 15 is also thin, the impact received by the upper section 15a is instantaneously transmitted to the lower section 15c through the central section 15b, whereby the lower section 15c absorbs the impact while being compressed and deformed. Because the upper section 15a is moved down by being compressed and deformed, a space s1 is created between a portion of the outer peripheral surface of the upper section 15a and the inner peripheral surface of the central section 16b of the housing 16. When the striking piston 7 is further moved down, as shown in FIG. 4C, the space s1 becomes filled with the outwardly bulged upper section 15a. Likewise, the space s, which is created between the lower section 15c of the bumper 15 and the inner peripheral surface of the housing 16 in the initial stage, becomes filled with the outwardly bulged lower section 15c. In contrast, because the wall thickness of the central section 15b of the bumper 15 is thick, the central section 15b is less deformable. Thus, the bumper 15 eventually deforms such that the wall thickness of the entire bumper becomes almost even. The height of the bumper 15 is designed to be compressed, when the striking piston 7 has reached the bottom dead center as shown in FIG. 4C, to about two thirds of the height before receiving the impact.

As described above, because there is no gap between the upper section 15a of the bumper 15 of the first embodiment and the housing 16, when the impact is received from the striking piston 7, the upper section 15a of the bumper 15 can only deform downward. Since the wall thickness of the central section 15b is thick, the central section 15b deforms only by a small amount. Therefore, the impact received by the upper section 15a is immediately transmitted to the bumper lower section 15c. Since there is a space s between the lower section 15c of the bumper 15 and the housing 16, the lower section 15c is easily deformable. Thus, even when the pressure of the compressed air is considerably high, the entire bumper 15 instantaneously deforms to enable reliable absorption of the impact.

The shape of the bumper is not limited to that of the first embodiment. For example, the external shape of the bumper may be a polygon such as an octagon or a decagon.

### Second Embodiment

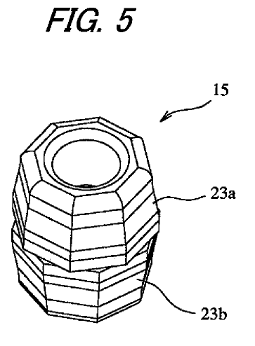

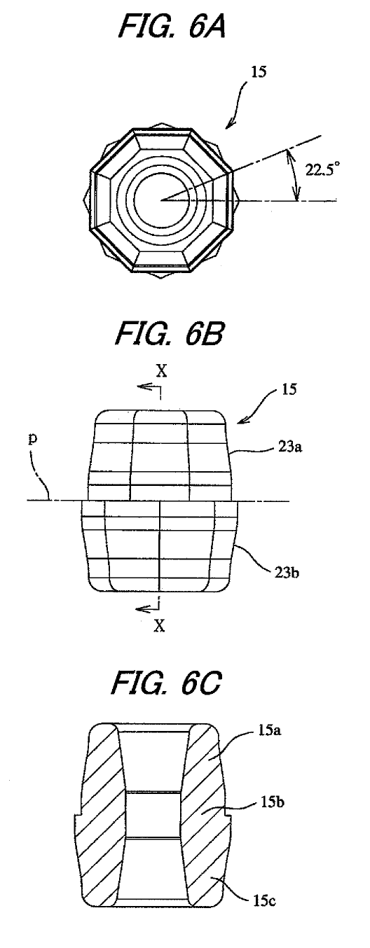

FIGS. 5 to 6C illustrate a bumper 15 according to a second embodiment. The bumper 15 of the second embodiment is similar to the bumper 15 of the first embodiment except for the shape of the outer peripheral surface. That is, the bumper 15 is formed in a tubular shape, a wall thickness of a central section 15b of the bumper 15 is thicker than wall thicknesses of an upper section 15a and a lower section 15c, and the wall thicknesses of the upper section 15a and the lower section 15c are about the same. An inner diameter of the central section 15b of the bumper 15 is smaller than inner diameters of the upper section 15a and the lower section 15c such that the inner peripheral surface of the bumper 15 is formed in a tapered shape. However, the outer peripheral surface of the bumper 15 is formed in an equilateral octagonal shape, and the upper half part 23a and the lower half part 23b are displaced from each other by 22.5 degrees in a rotating direction about the center of the equilateral octagon.

While the upper section 15a and the lower section 15c of the bumper 15 are displaced from each other by 22.5 degrees, further displacement by 22.5 degrees provides matching between corners of the outer peripheral surface of the upper section 15a and corresponding corners of the outer peripheral surface of the lower section 15c. Thus, shapes of the upper section 15a and the lower section 15c are substantially symmetric with respect to the central cross section p. Accordingly, the bumper may be inserted into the housing 16 of the nailer A from either end. Further, the bumper is stable while housed in the housing 16 since it is unlikely to be rotationally displaced.

According to the bumper 15 of the second embodiment, the upper section 15a deforms upon receipt of an impact from the striking piston 7 with the eight corner parts functioning like ribs. Therefore, the deformation is likely to occur in the vertical direction. More specifically, the upper section 15a is compressed and deformed downward in its entirety while expanding only slightly in a lateral direction. On the other hand, because the central section 15b is designed to have a thick wall thickness and sufficient mass to absorb the impact energy, the central section 15b is less deformable. Therefore, the impact received by the upper section 15a is immediately transmitted to the lower section 15c, causing the lower section 15c to be compressed and deformed. Accordingly, even when the pressure of the compressed air is considerably high, the entire bumper 15 is instantaneously deformed to reliably absorb the impact.

As described above, the bumper 15 according to one or more embodiments of the present invention provides the following advantageous effects.

Because the wall thicknesses of the upper section 15a and the lower section 15c of the bumper 15 are thin, the impact received by the upper section 15a is immediately transmitted to the bumper lower section 15c, whereby the upper section 15a and the lower section 15c are deformed. Therefore, a sudden increase in the impact force from the striking piston 3 is absorbed in a balanced manner by the upper and lower sections of the bumper 15. Thus, even when the pressure of the compressed air is considerably high, the entire bumper 15 is instantaneously deformed to reliably absorb the impact.

The flexural deformation of the bumper 15 is not partly biased and is uniform and balanced as a whole. Thus, a drop in the durability of the bumper 15 is rarely caused by partial degradation of the bumper 15. Moreover, because the central section 15b is formed to have a thick wall thickness so that a sufficient mass to absorb the impact energy is ensured, it is possible to provide a cushioning mechanism that is free from a so-called bottoming phenomenon without increasing the size of the bumper 15.

The bumper central section 15b is formed to have such an inner diameter that, when the bumper is maximally deformed due to the impact from the striking piston 7, the bumper central section 15b does not contact the driver 8. Therefore, the bumper central section 15b is prevented from being deteriorated or damaged by contact friction with the driver 8.

Further, the shapes of the upper section 15a and the lower section 15c of the bumper 15 are formed symmetricly with respect to the central section (the central cross section p). Therefore, when arranging the bumper 15 in the housing 16, there is no need to pay attention to the upper and lower sides of the bumper 15. That is, the bumper 15 is positioned in the right place irrespective of which end of the bumper 15 is first inserted into the housing 16. In contrast, because an upper section and a lower section of related art bumpers have different shapes, there has been a risk that inserting the bumper upside down may cause an accident.

The central section 15b of the bumper 15 is formed to have a thick wall thickness to have a sufficient mass, and the inner peripheral surface of the central section 15b has a reduced diameter to be in a tapered shape. Therefore, the upper section 15a and the lower section 15c of the bumper 15 are prevented from localized damage which may be cause by large inward flexure upon receipt of impact from the striking piston 7.

While the embodiments have been described above in connection with a pneumatic tool which uses compressed air, the bumper 15 according to the present invention provides similar effects also when applied to a gas combustion type tool or the like.

While the present invention has been described in detail with reference to specific embodiments, it will be apparent for those skilled in the art that various changes and modifications can be made therein without departing from the spirit and scope of the invention.

The present application is based on Japanese Patent Application No. 2006-228465 filed on Aug. 24, 2006, the content of which is incorporated herein by reference.

### INDUSTRIAL APPLICABILITY

It is possible to provide a power tool and a cushioning mechanism thereof which includes a bumper having an improved shock-absorbing function and durability without increasing its size.

1. A cushioning mechanism of a power tool, the power tool comprising a striking cylinder, a striking piston slidably housed in the striking cylinder, and a driver coupled to a bottom surface of the striking piston, wherein the cushioning mechanism receives the bottom surface of the striking piston when the striking piston is driven to strike a fastener with the driver; the cushioning mechanism comprising:
a housing formed below the striking cylinder; and
a bumper housed in the housing to receive the bottom surface of the striking piston,
wherein the bumper is formed in a tubular shape,
a wall thickness of a central section of the bumper is greater than wall thicknesses of an upper section and a lower section of the bumper, and
the wall thicknesses of the upper section and the lower section are substantially the same.

2. The cushioning mechanism according to claim 1, wherein a shape of the bumper is symmetric with respect to the central section.

3. The cushioning mechanism according to claim 1, wherein an inner diameter of the central section is smaller than inner diameters of the upper section and the lower section, and
an outer diameter of the central section is larger than outer diameters of the upper section and the lower section.

4. The cushioning mechanism according to claim 1, wherein the central section has such an inner diameter that, when the bumper is maximally deformed due to an impact from the striking piston, an inner peripheral surface of the central section does not contact the driver.

5. The cushioning mechanism according to claim 1, wherein outer peripheral surfaces of the upper section and the central section are in contact with an inner surface of the housing, and
a space is provided between an outer peripheral surface of the lower section and the inner surface of the housing.

6. A power tool comprising:
a striking cylinder;
a striking piston slidably housed in the striking cylinder;
a driver coupled to a bottom surface of the striking piston; and
a cushioning mechanism configured to absorb an impact of striking a fastener with the driver when the striking piston is driven,
wherein the cushioning mechanism comprises a housing formed below the striking cylinder, and a bumper housed in the housing to receive the bottom surface of the striking piston,
wherein the bumper is formed in a tubular shape,
a wall thickness of a central section of the bumper is greater than wall thicknesses of an upper section and a lower section of the bumper, and
the wall thicknesses of the upper section and the lower section are substantially the same.

7. The power tool according to claim 6, wherein a shape of the bumper is symmetric with respect to the central section.

8. The power tool according to claim 6, wherein an inner diameter of the central section is smaller than inner diameters of the upper section and the lower section, and
an outer diameter of the central section is larger than outer diameters of the upper section and the lower section.

9. The power tool according to claim 6, wherein the central section has such an inner diameter that, when the bumper is maximally deformed due to the impact from the striking piston, an inner peripheral surface of the central section does not contact the driver.

10. The power tool according to claim 6, wherein outer peripheral surfaces of the upper section and the central section are in contact with an inner surface of the housing, and
a space is provided between an outer peripheral surface of the lower section and the inner surface of the housing.
